(19) United States
(12) Patent Application Publication
(10) Pub. No.: US 2025/0041807 A1
(43) Pub. Date: Feb. 6, 2025

(54) POROUS MEMBRANES FOR FILTRATION MEDIA

(71) Applicant: DelStar Technologies, Inc., Alpharetta, GA (US)

(72) Inventors: Andrew G. Platt, Middletown, DE (US); Yasar Kiyak, Middletown, DE (US)

(21) Appl. No.: 18/788,396

(22) Filed: Jul. 30, 2024

Related U.S. Application Data
(60) Provisional application No. 63/517,656, filed on Aug. 4, 2023.

(51) Int. Cl. B01D 69/14; B01D 69/02

(52) U.S. Cl. CPC B01D 69/14111; B01D 69/02; B01D 2325/02831; B01D 2325/02832; B01D 2325/02833; B01D 2325/02834

(57) ABSTRACT

Porous membranes, and methods of making such porous membranes, that comprise staple or discrete fibers and nanoparticles dispersed throughout at least a portion of the membrane are provided. A filter media comprises a porous membrane comprising staple fibers and having a mean pore size of less than about 10 microns. The media further includes nanoparticles disposed within the porous membrane. The nanoparticles reduce the mean pore size of the membrane, while substantially maintaining the pressure drop (e.g., bubble point) across the membrane. The porous membranes may be configured for use as filter media and are particularly useful for gas or liquid filters, including, but not limited to, membrane filters, diesel filters, air filters, face masks, gas turbine and compressor air intake filters, panel filters, cartridge filters, bag filters, clean-in-place (CIP) filters and the like.

### CROSS-REFERENCE TO RELATED APPLICATIONS

This application claims the benefit of U.S. Provisional Application Ser. No. 63/517,656, filed Aug. 4, 2023, the complete disclosure of which is incorporated herein by reference for all purposes.

### TECHNICAL FIELD

This description generally relates to filtration media for gas or liquid filters and more specifically to porous membranes for such filters that comprise fibers and nanoparticles or shortcut fibers incorporated into the porous membrane.

### BACKGROUND

Porous membranes are widely used for a variety of applications depending on their properties such as the material used for making said membranes, their morphology, and the size of the membrane pores. For example, these membranes can be used, as filtration media, separation membranes, membrane adsorbers, and membrane catalysts.

One particular application for porous membranes is in liquid filtration. Liquid filtration is the process of removing solid particles, impurities, and contaminants that are suspended in a fluid stream. It generally involves the flow of the process liquid (in the form of slurries and suspensions) through a permeable filter medium and the blocking and retention of the captured solids.

There are two main types of liquid filtration: surface and depth. The filtration method is primarily distinguished from the structure of its filter medium. In surface filtration, the particle screening takes place on the surface of the filter medium. Interstitial spaces, called pores, are present between the fibers of the filter medium. Particles that have a larger diameter than the pore width are blocked on the upstream side of the filter medium and form the filter cake. Particles that have a smaller diameter than the pore width are allowed to pass through the filter medium. At the start of the filtration process, the filter efficiency is around 50-60%. It increases up to 100% as the filter cake builds up, as the filter cake also resists the flow of the particles.

Surface filters are economical in liquid filtration. However, this type of filtration has a lower particle holding capacity and is more prone to clogging. They also require more frequent replacements, but they can be reused after cleaning.

Depth filtration is used to retain the particles throughout the depth of the filter medium. Depth filters typically use a thick, multi-layered filter medium that increases its density towards the direction of the flow. The larger particles are retained on the surface of the filter, which has the least media density, and the particle size progressively becomes finer across the depth of the filter. The high pore volume of the filter presents a tortuous and difficult flow path for the solid to pass through. The greater resistance it offers effectively blocks the solid particles from combining into the filtrate.

Depth filters are typically used when the processed liquid contains a wide range of particle sizes. Depth filters can filter particles smaller than the mean pore size and they have a higher particle holding capacity and can trap a large volume of solids before they become clogged. They can remove gelatinous particles from the process liquid. Lastly, they have a long service life and are less frequently replaced but they are typically single-use products.

When identifying the required flow rate, the key considerations are pore size and required liquid throughput. The pore size of the membrane is selected based on the intended performance of the final device. The pore rating dictates the functional attributes of the membrane, including flow rate and throughput. For example, the use of membranes with smaller pore sizes will generally increase the efficiency of the filter in capturing contaminants. On the other hand, these smaller pore sizes will generally result in lower flow rates and reduced throughput compared to membranes with larger pore sizes.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Various embodiments provide porous membranes that comprise staple or discrete fibers and nanoparticles dispersed throughout at least a portion of the membrane as well as methods of making such porous membranes. Such porous membranes may be configured for use as filter media and are particularly useful for gas or liquid filters, including, but not limited to, filter presses, membrane bioreactor membranes, hydrocarbon filters, diesel filters, fluid filters, beverage filters, microfiltration membranes, downstream membrane filtration, air filters, face masks, gas turbine and compressor air intake filters, panel filters, cartridge filters, bag filters, clean-in-place (CIP) filters, battery separators and the like.

In one aspect, a filter media comprises a porous membrane having a mean flow pore size of less than about 10 microns. The membrane comprises staple fibers and nanoparticles disposed within the porous membrane. The nanoparticles reduce the mean pore size of the membrane, while substantially maintaining the flow rate and/or pressure drop through the membrane.

In embodiments, the mean flow pore size of the membrane is less than 5 microns, preferably less than 4 microns, and preferably less than 3 microns, preferably less than 1 micron.

In embodiments, the staple fibers are formed from wet-laid media comprising shortcut fibers, and may be generated by any conventional method. The staple fibers may have any suitable length, such as about 2 mm to about 80 mm.

The fibers may be artificial or natural. Suitable materials for the fibers include, but are not limited to, polyesters, polypropylene, (PET), PEN polyester, PCT polyester, polypropylene, PBT polyester, co-polyamides, polyethylene, high density polyethylene (“HDPE”), LLDPE, cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene, PVOH, PVA or any combination thereof. Other conventional fiber materials are contemplated.

In certain embodiments, the staple fibers comprise polyolefins, polyester, polyethylene (PE), polypropylene (PP), blends of PP and PE, PBT, PET, CoPET, PLA, PA, PHB, PVOH, PVA polyamide and a combination thereof. In a preferred embodiment, the fibers comprise polyester.

The fibers contemplated may have many shapes in cross-section, including without limitation, circular, kidney bean, dog bone, trilobal, barbell, bowtie, star, Y-shaped, and others. with different denier fiber ranges within each portion. The fibers may include biocomponent fibers that include two or more different fibers bonded to each other. The fibers may comprise the same material or different materials. The fibers may comprise biocomponent fibers having a core and a sheath. The core may be concentric or eccentric relative to the longitudinal axis of the sheath.

In certain embodiments, the nanoparticles are dispersed “in-depth” within the porous membrane. As used herein, the term “in-depth” means that the nanoparticles are dispersed beyond the first surface of the membrane such that at least some of the nanoparticles are disposed between the first and second opposing surfaces in the internal structure of the membrane. In certain embodiments, the nanoparticles are dispersed throughout substantially the entire membrane from the first surface to the opposing second surface. In other embodiments, the nanoparticles are dispersed through a portion of the membrane from the first surface to a location between the first and second surfaces.

In some embodiments, the nanoparticles are distributed three-dimensionally in space relative to the supporting fiber, which may increase fiber surface area and micro-volumes within the membrane. The three-dimensional distribution also provides resistance against complete blockage of a particular portion of the porous membrane, which is particularly useful in filter media as it allows liquid or gas to pass through the filter, thereby reducing the overall pressure drop across the filter.

The nanoparticles may be disposed on the first and second opposite surfaces of the membrane such that the area density of the nanoparticles decreases from the first surface towards the second surface, or a higher area density of nanoparticles is disposed on the two surfaces as compared to the middle section of the membrane. The density gradient formed by the nanoparticles through at least a portion of the membrane improves the performance characteristics of the filter. For example, the nanoparticles reduce the porosity of the membrane, which may increase its filtration efficiency allowing for the capture of contaminants without significantly compromising other factors, such as pressure drop (i.e., flow rate) through the filter.

In certain embodiments, the density of nanoparticles located at the first surface differs by less than 50% of the density of nanoparticles dispersed within the central portion or midpoint of the substrate between the two surfaces. In some embodiments, this difference is less than 25%, preferably less than 10%. In certain embodiments, the amount or number of individual nanoparticles dispersed within the central portion of the membrane is at least about 50% of the amount of individual nanoparticles dispersed at or near the first surface, preferably at least about 75% and more preferably at least about 90%.

In some embodiments, the nanoparticles may be added into the membrane from both the first and second surfaces. In these embodiments, the area density or “add-on amount” at the first and second surfaces may be substantially equal to each other, or they may be different depending on the application. In these embodiments, the area density or “add-on amount” that is present in the middle of the substrate is lower than at the outer surfaces. For example, the area density in the middle of the substrate may be about 75% of the area density at the outer surfaces, or it may be about 50%, 40% or 25%.

In certain embodiments, the nanoparticles are isolated within a fluid and dispersed through the first surface of the substrate. The fluid may, for example, be a gaseous medium such as air, helium, nitrogen, oxygen, carbon dioxide and the like. The nanoparticles may be dispersed from this gaseous medium via a gas stream, aerosol, vaporizer, spray, or other suitable delivery mechanism.

The nanoparticles may comprise any suitable material, such as glass, biosoluble glass, fibrillated cellulose, ceramic materials, acrylic, carbon, metal, such as alumina, polymers (such as nylon, polyethylene terephthalate, and the like), polyvinyl chloride (PVC), polyolefin, polypropylene, polyacetal, polyester, cellulose ether, polyalkylene sulfide, poly (arylene oxide), polysulfone, modified polysulfone polymers and polyvinyl alcohol, polyamide, polystyrene, polyacrylonitrile, polyvinylidene chloride, polymethyl methacrylate, polyvinylidene fluoride and any combination thereof.

In another aspect, a liquid filter comprises a porous membrane comprising fibers and having a mean flow pore size of less than about 10 microns. The filter has a bubble point (i.e., maximum measure pore size of the filter) of about 5 microns to about 50 microns, preferably less than about 30, or less than about 20 microns, or less than about 10 microns, or about 5 microns.

In embodiments, the mean pore size of the membrane is less than 5 microns, preferably less than 4 microns, preferably about 3 microns, and preferably less than 1 micron.

In embodiments, the staple fibers are wet-laid fibers and may be generated by any conventional methods. The staple fibers may have any suitable length, such as about 2 mm to about 80 mm.

The liquid filter may comprise, for example, a clean-in-place (CIP) filter, a bag filter, a cartridge filter, or the like. Such cartridge filters may include, for example, pleated cartridges, spun-bonded cartridges, activated carbon filter cartridges, reverse osmosis membrane cartridges, alkaline filter cartridges, ultraviolet filter cartridges, and the like.

In another aspect, a method of manufacturing a filter media comprises providing a porous membrane comprising fibers and dispersing nanoparticles into the first surface of the porous membrane such that the nanoparticles penetrate through at least the first surface of the membrane.

In embodiments, the method further comprises calendering the staple fibers and the nanoparticles to reduce the mean pore size of the porous membrane to less than about 10 microns, preferably less than about 5 microns, and more preferably less than about 3 microns.

In embodiments, the fibers are staple fibers processed through a wet-laid process.

In certain embodiments, the nanoparticles are isolated within a fluid and dispersed through the first surface of the porous membrane. The fluid may, for example, be a gaseous medium such as air, helium, nitrogen, oxygen, carbon dioxide and the like. The nanoparticles may be dispersed from this gaseous medium via a gas stream, aerosol, vaporizer, spray, or other suitable delivery mechanism.

In embodiments, the method further comprises advancing the porous membrane from an upstream end to a downstream end and feeding groups of nanofibers into a fluid medium. The groups of nanofibers are converted into nanoparticles within the fluid medium and then dispersed into the porous membrane between the upstream and downstream ends to form a fibrous material.

The process may further comprise applying an adhesive to the fibers within the porous membrane. The adhesive may be, for example, spray-coated onto the membrane before and/or after the nanoparticles are dispersed therein. The adhesive inhibits the nanoparticles from passing right through the membrane and may increase the uniformity and penetration of the nanoparticles within the internal structure of the membrane as they bind to the adhesive.

The recitation of desirable objects which are met by various embodiments herein is not meant to imply or suggest that any or all of these objects are present as essential features, either individually or collectively, in the most general embodiment of the present description or in any of its more specific embodiments.

### BRIEF DESCRIPTION OF THE DRAWINGS

FIG. 1 is a side sectional view of a porous membrane with nanoparticles dispersed into a portion of the material;

FIG. 2 is a side sectional view of a porous membrane with nanoparticles dispersed throughout the material;

FIG. 3 is a side sectional view of a porous membrane with nanoparticles dispersed in a gradient through the material;

FIG. 4 is side sectional view of a dual-layer filter with nanoparticles dispersed in a gradient through the material;

FIGS. 5A-5C illustrate representative biocomponent fibers for incorporation into a porous membrane;

FIG. 6 illustrates a liquid cartridge filter;

FIG. 7 illustrates a liquid bag filter;

FIG. 8 schematically illustrates a system for manufacturing a porous membrane incorporating nanoparticles;

FIG. 9 schematically illustrates a system for converting clusters of nanofibers into individual nanoparticles;

FIGS. 10-12 are photographs of macro clusters of nanofibers, smaller clusters of nanofibers and individualized nanoparticles, respectively.

FIG. 13 illustrates an eductor of the system of FIG. 8;

FIG. 14 illustrates a reactor of the system of FIG. 8;

FIG. 15 illustrates another embodiment of a system for converting clusters of nanofibers into individual nanoparticles;

FIG. 16 illustrates a porous membrane with nanoparticles dispersed through a depth of the material;

FIG. 17 illustrates a porous membrane with nanoparticles dispersed through a depth of the material and a scrim layer overlying the nanoparticles;

FIG. 18 illustrates a dual-layer porous membrane with nanoparticles dispersed onto the inner surfaces of the two layers; and

FIGS. 19A-19C have been deleted.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the words “about” or “approximately” or the like are stated or not. The materials, methods, and examples provided herein are illustrative only and not intended to be limiting.

Various embodiments provide porous membranes that comprise staple or discrete fibers and nanoparticles dispersed throughout at least a portion of the membrane. Such porous membranes may be configured for use as a filter media and are particularly useful for gas or liquid filters, including, but not limited to, air filters, face masks, gas turbine and compressor air intake filters, panel filters, cartridge filters, bag filters, clean-in-place (CIP) filters, battery separators and the like.

Various embodiments also provide systems, devices, and methods for producing the porous membrane and the products containing the porous membrane (e.g., gas or liquid filters). Such systems and methods may include isolating individual nanoparticles in a gaseous medium, such as air, helium, nitrogen, oxygen, carbon dioxide, and the like (instead of a liquid) and dispersing the nanoparticles into the porous membrane via a gas stream, aerosol, vaporizer, spray or other suitable delivery mechanism.

While the following description is primarily presented with respect to porous membranes and filter media, it should be understood that the devices and methods disclosed herein may be readily adapted for use in a variety of other applications. For example, the porous membranes disclosed herein may be useful in household cleaning products, roofing and flooring products, automobile upholstery and headliners, reusable bags, wallcoverings, filtration devices, insulation, and the like. In addition, the individual nanoparticles that are isolated and generated may be utilized in various coatings, composites, and/or additives in, for example, polymers, food packaging, flame retardants, fuel cells, batteries, capacitors, nanoceramics, lights, material fabrication, manufacturing methods, reinforcement for composites, cement and other materials, medical diagnostic applications, medical therapeutic devices or therapies, tissue engineering, such as scaffolds for bone or tissue repair, potable waters, industrial process fluids, food and beverage products, pharmaceutical and biological agents, tissue imaging, medical therapy delivery, environmental applications, such as biodegradable compounds and the like.

The porous membrane preferably has a mean or average pore size of less than about 10 microns. In embodiments, the mean pore size of the membrane is less than 5 microns, preferably less than 4 microns, and more preferably about 3.8 microns. The nanoparticles reduce the mean pore size of the membrane, while substantially maintaining the pressure drop (e.g., bubble point) across the membrane.

In an exemplary embodiment, the membrane has a porosity value of at least 50% or 40%, preferably at least 20% or 5%. Porosity value is defined as the nonsolid or pore-volume fraction of the total volume of the material.

In embodiments, the filter has a bubble point of about 5 microns to about 50 microns, preferably less than about 30, or less than about 20 microns, or less than about 10 microns, or about 5 microns.

The porous membrane may have a thickness suitable for the particular application. In certain embodiments, the membrane has a thickness of about 0.2 mm to about 5 mm, preferably about 0.5 to about 3 mm.

The contemplated fibers of the substrate are preferably manufactured by a wetlaid method, which typically involves providing staple or discrete fibers of about 2 mm to about 15 mm in length, preferably about 4 mm to about 8 mm. The fibers are suspended in a fluid, such as water, in a large tank. The fibers may be mixed with viscose or wood pulp. After mixing, the water-fiber or water-pulp dispersion is pumped and continuously deposited onto a frame or forming wire. The water is then evacuated until the fibers are substantially dry.

The fibers contemplated may have many shapes in cross-section, including without limitation, circular, kidney bean, dog bone, trilobal, barbell, bowtie, star, Y-shaped, and others. These shapes and/or other conventional shapes may be used with the embodiments to obtain the desired performance characteristics. The fibers in the substrate stay connected to each other through thermal bonds, and chemical bonds, by being entangled with one another, through the use of binding agents, such as adhesives, or the like.

The fibers may be artificial or natural fibers. Suitable materials for the fibers include, but are not limited to, polypropylene, polyesters (PET), PEN polyester, PCT polyester, polypropylene, PBT polyester, co-polyamides, polyethylene, high density polyethylene (“HDPE”), LLDPE, cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, PVOH, PVA, styrene or any combination thereof. Other conventional fiber materials are contemplated.

In certain embodiments, the staple fibers comprise polyolefins, polyester, polyethylene (PE), polypropylene (PP), blends of PP and PE, PBT, PET, COPET, PLA, PA, PHB, polyamide, and a combination thereof. In a preferred embodiment, the fiber comprises polyester.

The fibers may include fibers of different sizes, with the fibers generally having diameters ranging from about 1 to about 1000 microns. The fibers may be configured as a gradient density media in which the pore size decreases from the upper surface of the filter (upstream) to the lower surface (downstream) to increase capture efficiency and dust holding capacity. This configuration also allows for the dispersion of different amounts of nanoparticles to the filter media at different depths. For example, the upstream side of the filter media may have the largest fiber size to allow for more void space and a greater density of nanoparticles, while the downstream side of the filter media has fibers with smaller sizes to provide a lower density of nanoparticles. Alternatively, this structure may be reversed to provide a greater density of nanoparticles in the downstream portion of the filter media.

The porous membrane discussed herein may comprise a structure of individual fibers or threads that are interlaid, interlocked, or bonded together. The porous membranes may include sheets or web structures bonded together by entangling fiber or filaments (and by perforating films) mechanically, thermally, or chemically. They may be substantially flat, porous sheets that are made directly from separate fibers or molten plastic or plastic film.

In certain embodiments, the porous membrane may comprise a knitted and/or woven material. The knitted material may comprise any knitting pattern suitable for the desired application. Suitable knitted materials for filter applications include weft-knit, warp-knit, knitted mesh panels, compressed knitted mesh, and the like. Suitable woven materials for filter applications include textile filter media, such as monofilament fabrics, multifilament fabrics, nylon mesh, polyester mesh, polypropylene mesh, and the like. Woven textiles may be used in, for example, mesh filter press cloths, woven filter pads and other die-cut pieces, centrifuge filter bags, liquid filter bags, dust collector bags, bed dryer bags, rotary drum filters, filter belts, leaf filters, roll media and the like.

The fibers in the media may stay connected to other fibers by being thermally bonded, chemically bonded, or entangled with one another. Bicomponent fibers may be used, particularly with mechanical filtration, and these are formed by extruding two polymers from the same spinneret with both polymers contained within the same filament. Suitable materials for bicomponent fibers include but are not limited to, polypropylene (PP)/polyethylene (PE), polyethylene terephthalate (PET)/polypropylene (PP), and the like. Alternatively, the fibers in the media may be connected to other fibers by a binder fiber such as polyvinyl alcohol.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in the linear mass density of fibers. In some embodiments, the fibers may have a linear density of about 1 denier to about 10 denier. The nanoparticles are fibers having at least one dimension in the range of about 1 to about 1,000 nanometers or about 1 to about 100 nanometers. The dimensions described above fibers and nanoparticles may be a diameter or a width, depending on the shape of the fiber or nanoparticle.

For gas filters, such as pleated or unpleated air filters, the fibers may have a linear density in the range of about 1 denier to about 10 deniers. The filter media may comprise fibers with the same or different linear densities. Fibers in air filters typically have a linear density of about 3-6 denier or less to ensure that the fibers are small enough to capture contaminants passing through the filter. The applicant has surprisingly found that with the use of nanoparticles dispersed through the filter media, the fibers may have larger linear densities, e.g., greater than 3 deniers. This is because the nanoparticles provide a significant filtering capability. In some cases, the fibers may have linear densities of greater than 3 denier, 5 denier or greater, 6 denier or greater, or as large as 7-10 denier.

For liquid filters, the fibers may have a linear density in the range of about 3 deniers to about 1 denier, preferably about 0.1 to about 5.

In some embodiments, the filters include one or more support layers bonded to the filter media. The support layers and/or the filter media may include nanoparticles dispersed in depth within the layer(s). In some embodiments, polymer layers, membranes, or films are provided that include one or more apertures for the flow of gas or liquid therethrough with nanoparticles disposed in depth within the polymer layer. In other embodiments, the material comprises a flexible surface layer for a finger bandage pad, a face mask, or the like.

In some embodiments, the nanoparticles have at least one dimension less than about 20 microns. In some embodiments, the nanoparticles have at least one dimension less than 1 micron (i.e., diameter, width, height, or the like depending on the cross-sectional shape of the fiber). In other embodiments, the nanoparticles comprise mini-fibers or nanofibers that have at least one dimension between about 1 micron to about 20 microns. For example, a mini-fiber or nanofiber having a diameter or width less than a micrometer and a length greater than 1 micrometer is a nanoparticle as used herein. In an exemplary embodiment, the mini fibers have at least one dimension of about 5 microns. The nanoparticles may have a continuous length, or the nanoparticles may have discrete length, such as 1 to 100,000 microns, preferably between about 5 to 10,000 microns, or between about 5 to about 1,000 microns, or about 100 to about 600 microns.

In certain embodiments, each individual nanoparticle may be a small particle that ranges between about 1 to about 1000 nanometers in size, preferably between about 100 to about 750 nanometers. The particle size of at least half of the particles in the number size distribution may measure 800 nanometers or below. The material properties change as the size of the nanoparticles approaches the nanoscale. This is due to the surface area to volume ratio increasing, resulting in the material's surface atoms dominating the material performance. Owing to their very small size, nanoparticles have a very large surface area-to-volume ratio when compared to bulk material, such as powders, plates, sheets, or larger fibers. This feature enables nanoparticles to possess unexpected optical, physical, and chemical properties, as they are small enough to confine their electrons and produce quantum effects.

In certain embodiments, the nanoparticles are dispersed “in-depth” within the substrate. As used herein, the term “in-depth” means that the nanoparticles are dispersed beyond the first surface of the substrate such that at least some of the nanoparticles are disposed between the first and second opposing surfaces into the internal structure of the substrate or media. In certain embodiments, the nanoparticles are dispersed throughout substantially the entire media from the first surface to the opposing second surface. In other embodiments, the nanoparticles are dispersed through a portion of the media from the first surface to a location between the first and second surfaces.

In some embodiments, the nanoparticles are distributed three-dimensionally in space relative to the supporting fiber, which may increase fiber surface area and micro-volumes within the nonwoven material. The three-dimensional distribution also provides resistance against complete blockage of a particular portion of the nonwoven material, which is particularly useful in filter media as it allows fluid (e.g., air and other gases) to pass through the filter, thereby reducing the overall pressure drop across the filter.

In other embodiments, the nanoparticles are disposed in a density gradient across the thickness of the substrate such that a higher density of nanoparticles is disposed near one surface than the opposite surface, or a higher density of nanoparticles is disposed on the surfaces as compared to the middle section of the substrate. The density gradient shown in may be substantially linear, it may reduce in a series of discrete steps, or the gradient may be random (i.e., a general reduction in density that is not linear or stepped). This density gradient provides a number of advantageous features for certain applications, such as filters (as discussed below).

The nanoparticles may comprise any suitable material, such as glass, biosoluble glass, non-biopersistent glass fiber, ceramic materials, acrylic, carbon, metal, such as alumina, polymers (such as nylon, polyethylene terephthalate, and the like), polyvinyl chloride (PVC), polyolefin, polyacetal, polyester, cellulose ether, polyalkylene sulfide, poly (arylene oxide), polysulfone, modified polysulfone polymers and polyvinyl alcohol, polyamide, polystyrene, polyacrylonitrile, polyvinylidene chloride, polymethyl methacrylate, polyvinylidene fluoride, fibrillated cellulose, and any combination thereof.

In some embodiments, nanoparticles may be produced as bicomponent segmented pie and islands in the sea. Then filaments are drawn so much so that submicron filaments are obtained. Continuous filament nanofibers are cut according to the desired length, preferably between about 100 to about 10000 microns.

In some embodiments, nanoparticles are absorbents and adsorbents. In some embodiments, nanoparticles are activated carbon fibers or activated carbon powders. In some embodiments, nanoparticles are catalytic particles or catalytic fibers. In some embodiments, nanoparticles can be obtained by feeding a submicron fiber nonwoven in a shredder or a crusher or edge trimmer machine where bonded nonwoven gets in and shortcut fiber comes out. For instance, low weight biocomponent meltblown or nano meltblown fabric can be fed into a shredder and submicron nanoparticles can be obtained.

In some embodiments, different nanoparticles may be mixed. For example, nanofibers and nanobeads can be mixed. Two different nanofibers with different melting points can also be mixed so that lower melting point nanoparticles can act as binders for higher melting point nanofibers. Nanoparticles with different diameters and different lengths can be mixed as well.

In some embodiments, nanoparticles are chosen from environmentally sustainable raw materials. Nanoparticles may compromise biosoluble glass nanofibers, biodegradable nanoparticles, compostable nanoparticles, fibrillated cellulose, cellulose, or recyclable compositions.

Nanoparticles of different types can be combined. Some of the nanoparticles can be functional nanoparticles. For example, the functional nanoparticles may include activated carbon and/or antimicrobial material deposited onto and/or attached to the fibers in the nonwoven material. This may improve the gas absorption efficiency of the fibers and the effectiveness of killing bacteria. In addition, a nonwoven product of a microfiber nonwoven with nanoparticles of glass and carbon deposited into it would provide filtration and odor-removing functionality as a filter medium.

In some embodiments, the nanoparticles are bonded to the fibers via mechanical entanglement. This mechanical bond can be supplemented with an adhesive or binding agent, as discussed in more detail below. In certain embodiments, the nanoparticles are not crimped (i.e., they do not include significant wavy, bent, curled, coiled sawtooth or similar shape associated with the nanoparticle in a relaxed state. In other embodiments, the nanoparticles may have a crimped body structure with a discrete length. For instance, when these crimped nanofibers having a discrete length are attached to the fiber, they entangle among themselves and also with, onto, and around, the fiber with a firm attachment to form a modified fiber. In other embodiments, the attachment of the nanofibers to the micron fibers is accomplished via electrostatic charge attraction and/or Van der Waals force attraction between the fibers and the nanoparticles.

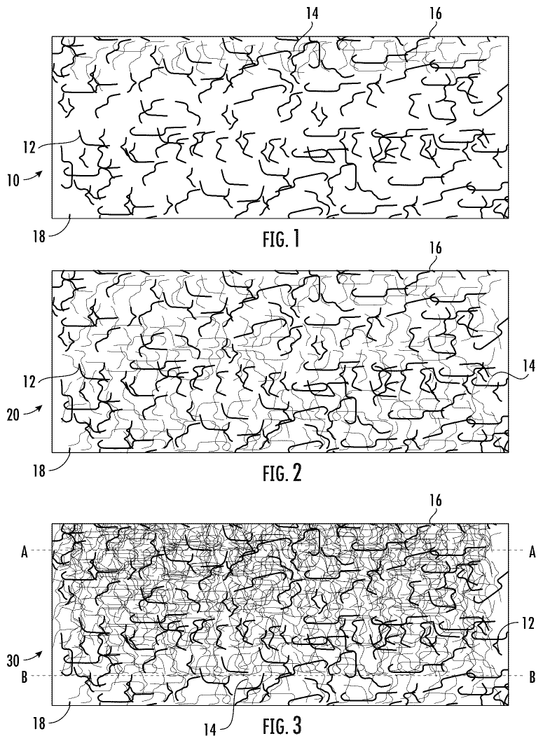

FIG. 1 illustrates a cross-sectional view of porous membrane 10 that includes a plurality of fibers 12 and nanoparticles 14. Membrane 10 has a first surface 16 and a second surface 18 opposing the first surface 16 and defined a width or thickness between the first and second surfaces 16, 18. The nanoparticles 14 have been deposited into the membrane through the first surface 16. As shown, nanoparticles 14 penetrate through first surface 16 into the “depth” of the membrane 10 between the first and second surfaces 16, 18. In some embodiments, the nanoparticles 14 penetrate from the first surface at least 25% of the width or thickness between the first and second surfaces 16, 18, or more preferably at least about 50% of the thickness. In other embodiments, the nanoparticles 14 penetrate substantially throughout the membrane the from first surface 16 to the second surface 18.

The nanoparticles 14 preferably comprise individual nanoparticles that have been broken up, separated, and isolated from each other prior to dispersion into membrane 10. As such, the nanoparticles 14 are not present in the membrane in a layer and do not have significant clumping or bundles of nanofibers. This provides a greater dispersion of nanoparticles throughout the membrane, which in some applications, such as liquid filters, decreases the mean pore size of the membrane. In addition, this provides a porous membrane with a greater area density of nanoparticles in grams per square meter (gsm) within the material or “add-on amount”. The term “add-on amount” is used herein to mean the area density (gsm) of a material, fiber, or particle in a thin layer, sheet, or film of material.

In certain embodiments, the nanoparticles may comprise an add-on amount of about 0.1 grams/m² to about 20 grams/m², preferably at least about 2.0 grams/m². The specific add-on amount or area density may depend on the application. For example, the applicant has found that a higher area density or add-on amount will decrease the mean pore size of the membrane. Thus, the specific add-on amount of nanoparticles may depend on the desired efficiency of a filter media.

FIG. 2 illustrates a cross-sectional view of a porous membrane 20 that includes a plurality of fibers 12 and nanoparticles 14. As shown, nanoparticles 14 penetrate throughout the entire width of membrane 20 from the first surface 16 to the second surface 18. In certain embodiments, the nanoparticles 14 are substantially dispersed throughout the fibers 12 of the membrane, as shown in FIG. 2. In certain embodiments, the density of nanoparticles located at first surface 16 differs by less than 50% of the density of nanoparticles dispersed within the central portion of membrane 20 between surfaces 16, and 18. In some embodiments, this difference is less than 25%, preferably less than 10%. In certain embodiments, the amount or number of individual nanoparticles dispersed within the central portion of membrane 20 is at least about 50% of the amount of individual nanoparticles dispersed at or near the first surface 16, preferably at least about 75% and more preferably at least about 90%.

In other embodiments, nanoparticles 14 are disposed of in a density gradient from first surface 16 to the second surface 18. For example, FIG. 3 illustrates a cross-sectional view of a membrane 30 wherein the nanoparticles 14 form a density gradient with a higher density of nanoparticles 14 disposed near the first surface 16 than the second surface 18. In certain embodiments, the density of nanoparticles located at first surface 16 differs by greater than about 75% of the density of nanoparticles dispersed at second surface 18. In some embodiments, this difference is greater than 50%. In some embodiments, the difference is greater than 25%. In certain embodiments, the amount or number of individual nanoparticles dispersed at or near the second surface 18 is less than about 50% of the amount of individual nanoparticles dispersed at or near the first surface 16, preferably less than about 25% and more preferably less than about 10%.

The density gradient is shown in FIG. 3 may be substantially linear from the first surface 16 to the second surface 18. Alternatively, the density of the nanoparticles 14 may reduce from the first surface 16 to the second surface 18 in a series of discrete steps, or the gradient may be random (i.e., generally, a reduction in density that is not linear or stepped).

In other embodiments, the nanoparticles may be added into the membrane from both the first and second surfaces 16, 18. In these embodiments, the area density or “add-on amount” at the first and second surfaces 16, and 18 may be substantially equal to each other, or they may be different depending on the application. In these embodiments, the area density or “add-on amount” that is present in the middle of the substrate is lower than at surfaces 16, and 18. For example, the area density in the middle of the membrane may be about 75% of the area density at surfaces 16, and 18, or it may be about 50%, 40%, or 25%.

The distribution of nanoparticles across the thickness of the membrane can be measured, for example, using imaging techniques. A magnified view of the membrane, using an electron microscope or other techniques, taken at a horizontal section of the product at the middle of the thickness of the product can be compared to an image taken at the upper or lower surface of the product, or all three images can be compared, to determine the extent to which the amount of nanoparticles deposited varies. Computerized image analysis processing can be employed. For example, in FIG. 3, a section can be taken at line A-A and a section can be taken at B-B. A top view image of each section can be taken through electron microscope, scanning electron microscopy, and other microscopes. A top view image of the section taken at section A-A, for example, can be compared to a top view image taken at section B-B. The number of microfibers, the number of nanoparticles, or both, in samples of the same two-dimensional size can be assessed and compared. In addition, imaging techniques can be used on three-dimensional samples. These techniques can be used to assess the orientation of fibers and other characteristics. These techniques can be used to determine that nanoparticles have been deposited into the depth of the substrate, have been deposited substantially across a significant portion of the substrate, substantially across the entire depth, or across some portion of the depth of the substrate.

The applicant has also found that, in some applications, fibers with larger linear densities than those used in conventional filters (e.g., greater than about 3 denier) provide more open space or pores within the filter media, which allows for a greater density of nanoparticles to be dispersed therein. While this may be counterintuitive to those of skill in the art, the applicant has discovered that fibers with larger linear densities that incorporate nanoparticles improve the overall efficiency of the filter.

In certain embodiments, a filter media may include at least two different fiber thicknesses or linear densities to provide at least two different layers of the filter within the same filter media. For example, in some cases, one portion of the filter media will include fibers with linear densities greater than 3 denier, 5 denier or greater, or 6 denier or greater. The other portion of the filter media will comprise fibers with more standard linear densities of 3 denier or less. This dual-layer filter media creates a first filter portion that filters contaminants primarily with nanoparticles that have a high density within the larger thickness fibers and a second filter portion that filters contaminants primarily with the fibers having lower linear densities, although both portions may include nanoparticles dispersed throughout the fibers. In certain embodiments, the filter media may include three or more separate portions or layers with different denier fiber ranges within each portion.

FIG. 4 illustrates a cross-sectional view of a dual layer filter media that includes a first porous membrane 40 having a first surface 42 and a second surface 44 opposing the first surface, and a second porous membrane 50 having a first surface 52 and a second surface 54 opposing the first surface. Second surface 44 of membrane 40 is bonded to second surface 54 of the first membrane in any manner known to those skilled in the art. First membrane 40 contains fibers 46 of relatively smaller linear density, e.g., on the order of 3 denier or less. Second membrane 50 contains fibers 56 of relatively larger linear densities, e.g., on the order of 3 denier or greater, such as 5 denier, 6 denier, or larger. Second membrane 50 also includes individual nanoparticles 58 dispersed throughout and bonded to fibers 56 and/or retained by second membrane 50. First membrane 40 may, or may not, also include nanoparticles.

First membrane 40 is configured to filter contaminants primarily with fibers 46, although as mentioned previously, first membrane 40 may also include nanoparticles. The second membrane 50 is configured to filter contaminants with both fibers 56 and nanoparticles 58.

In some embodiments, the porous membrane may compromise additives, such as antibacterial and/or antiviral compositions such as silver, zinc, copper, organosilicon, tributyl tin, and organic compounds that contain chlorine, bromine, or fluorine compounds.

The fibers may include biocomponent fibers that include two or more different fibers bonded to each other. The fibers may comprise the same material or different materials.

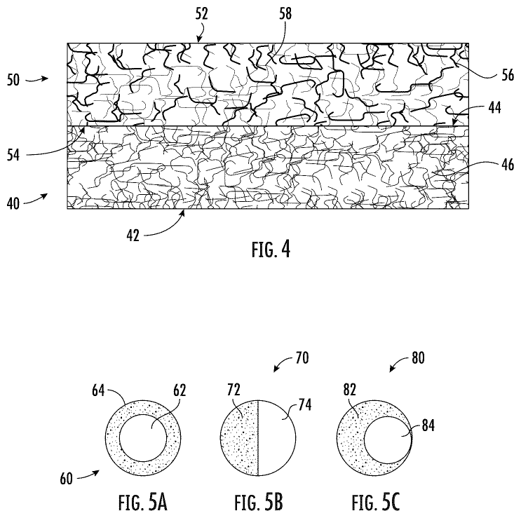

FIGS. 5A-5C illustrate different examples of biocomponent fibers that may be used with the porous membranes disclosed herein. FIG. 5A illustrates a fiber 60 having a core fiber 62 and a surrounding sheath fiber 64. In this embodiment, the core 62 is substantially co-centric with the sheath. FIG. 5B illustrates a biocomponent fiber 70 having first and second fibers 72, and 74 that are disposed side-by-side with each other. FIG. 5C illustrates a biocomponent fiber 80 having a core fiber 82 and a sheath fiber 84. In this embodiment, core 82 is eccentric relative to the longitudinal axis of sheath 84, which increases the overall loftiness of the biocomponent fiber. Of course, other configurations are possible. For example, the core may comprise shapes other than circular, such as dog-bone shaped, square, triangular, diamond or the like. Alternatively, the fiber may comprise multiple cores, or it may be split into three, four or more quadrants.

In certain embodiments, the fibers may include a silicone-based coating to improve the efficiency of the filter media at capturing contaminants, particularly contaminants in the E2 and E3 particle group range. The silicone-based coating may comprise a reactive silicone macroemulsion. The silicone emulsion may comprise, for example, dimethyl silicone emulsions, amino-type silicone emulsions, organo-functional silicone emulsions, resin-type silicone emulsions, film-forming silicone emulsions, or the like. In one embodiment, the reactive silicone macroemulsion comprises an amino-functional polydimethylsiloxane and/or a polyethylene glycol monotridecyl ether. Suitable silicone coatings are described in commonly assigned U.S. Provisional Patent Application Ser. No. 63/406,686, filed Sep. 14, 2022, the complete disclosure of which is incorporated herein by reference.

In some embodiments, the filter media may be scored, pleated, or folded into a pleated filter. The pleats may be formed by various conventional pleating operations that include, but are not limited to, bar, rotary, and star gear pleating operations. Filters include one or more support layers bonded to the filter media. In some embodiments, polymer layers, membranes, or films are provided that include one or more apertures for the flow of gas or liquid therethrough. In other embodiments, the material comprises a flexible surface layer for a finger bandage pad, a face mask, or the like.

In certain embodiments, the fibers may be included in, or bonded to, a thin film or layer that includes apertures, pores, or perforations. The apertures may be embossed in a pattern (such as circular, diamond-shaped, hexagonal, oblong, triangular, rectangular, etc.) and then stretched until apertures form in the thinned-out areas created by the embossing. Such an apertured substrate can be formed from many polymers, such as polypropylene, polyethylene, high-density polyethylene (“HDPE”), and the like. The polymer layer may, for example, comprise an extruded film. An apertured film is available commercially and is marketed under the trademark Delnet®. The substrate is provided in a roll and nanofibers are deposited into the substrate in a roll-to-roll process.

In certain embodiments, the porous membrane (i.e., the fibers and/or the nanoparticles) may be electrostatically charged such that, for example, contaminants are captured both with mechanical and electrostatic filtration. The bond between the fibers and the nanoparticles may also be enhanced by electrostatically charging the nanoparticles, the fibers, or both. For example, in certain embodiments, the fibers are electrostatically charged such that mechanical filtration can be achieved by nanoparticles while electrostatic filtration can be achieved through an electret substrate. The electrostatic or electret substrate could be high-loft triboelectric filter media made by carding and needling. In one of the embodiments, the nanoparticles are preferably deposited into the substrate before needling and then both electrostatic fibers and nanoparticles are needled together.

The membrane, the nanoparticles, or both can be electrostatically charged using triboelectric methods, corona discharge, electrostatic fiber spinning, hydro charging, charging bars, or other known methods. Corona charging is suitable for charging monopolymer fiber blends, or fabrics. Tribocharging may be suitable for charging fibers with dissimilar electronegativity. Electrostatic fiber spinning combines the charging of the polymer and the spinning of the fibers as a one-step process. Suitable methods for triboelectric charging are described in commonly assigned U.S. Provisional Patent Application No. 63/410,729, filed Sep. 28, 2022, and U.S. Pat. No. 9,074,301, the entire disclosures of which are hereby incorporated by reference herein for all purposes.

The filtration media may comprise a charge additive to modify the triboelectric charge of the fibers and increase the stability and/or duration of the triboelectric charge in the filter. This increases the overall filtration efficiency of the filter without compromising other important characteristics of the filters, such as longevity, dust holding capacity, and the pressure drop or airflow through the filter. Suitable charge additives for triboelectric charging are described in commonly assigned U.S. Provisional Patent Application Ser. No. 63/410,731, filed Sep. 28, 2022, the entire disclosures of which are hereby incorporated by reference herein for all purposes.

The nanoparticles can be chosen with different triboelectric properties relative to the fibers in order to use a triboelectric effect to enhance particle removal. With this method, the generated nanoparticles are formed in an electrical field and are less subject to contamination by chemicals that may moderate the triboelectric effect. Nanoparticles with different adsorption properties or surface charge characteristics than the coarse fibers can also be used, e.g. in oil or water filtration. This difference can be used to enhance or create localized electrical field gradients within the filter media to enhance particle removal. The nanoparticles and coarse fibers may have different wetting characteristics.

The membrane may include a binding agent or binding material, such as an adhesive or binder, to facilitate the bond between the fibers and/or the retention of the nanoparticles in the membrane so that the nanoparticles can adhere to the fibers, or otherwise be retained by the fibers, within the substrate to form a stable matrix. The binding agent or binding material is preferably present in relatively small amounts to bond the individual nanoparticles to fibers throughout the substrate.

The binding agent may comprise a variety of conventional materials, including natural-based materials, such as starch, dextrin, guar gum, or the like, or synthetic resins such as EVA, PVA, PVOH, SBR, polyglycolic, and the like. In certain embodiments, solvent-based adhesives are used in which bonding occurs upon solvent evaporation.

In one preferred embodiment, the binding agent or binding material comprises a dextrin. In yet another embodiment, the binding agent comprises a composition of various substances, such as water, 2-hexoxyethanol, isopropanolamine, sodium dodecylbenzene sulfonate, lauramine oxide, and ammonium hydroxide. In yet another embodiment, the binding agent comprises at least a PVOH. Binding agents could be in solution, emulsion, suspension, hot melt, curable, neat, and/or a combination.

In some embodiments, an adhesive resin is used and the adhesive resin may undergo cross-linking after the coating of the adhesive on the substrate. Adhesion (water/solvent resistance) may be promoted by self-crosslinking as the solvent in the adhesive formulation evaporates or by heat activation during drying process. In the case of certain adhesives, crosslinking can be accomplished through high energy wavelengths of electromagnetic radiation including, but not limited to. RF, UV, or e-beam. The amount of adhesive can be controlled by adjusting the nozzle size of spray coater 140 or controlling the flow rate of the adhesive composition. The binding agent can be applied using spray nozzles, dip coating, or other methods.

In some embodiments, the binding agent or binding material may include a surfactant to lower the surface or interfacial tension of the binding agent, thereby increasing its dispersion and wetting properties and allowing the binding agent to more easily penetrate into the depth of the membrane. Suitable surfactants for use with the adhesives disclosed herein include nonionic, anionic, cationic and amphoteric surfactants, such as sodium stearate, 4-(5-dodecyl) benzenesulfonate, sodium dodecylbenzene sulfonate wetting agents, docusate (dioctyl sodium sulfosuccinate), alkyl ether phosphates, benzalkonium chloride (BAC), perfluorooctanesulfonate (PFOS) and the like.

In some embodiments, the membrane includes its own binder composition. In these embodiments, the binding agent or binding material may, or may not, be added to the membrane. In one such embodiment, the substrate comprises biocomponent fibers, wherein one of the components comprises an outer sheath at least partially surrounding an inner core (see FIGS. 5A and 5C).

The sheath may comprise a material that bonds to the nanoparticles. For example, the sheath may comprise a material that becomes tacky and/or fluid upon heating and/or drying. During the heating/drying step (discussed below), the sheath part of the fiber is heated up to its melting point until it becomes tacky and/or fluid to bond the nanoparticles to the substrate. In a preferred embodiment, bonding and drying take place at the same time.

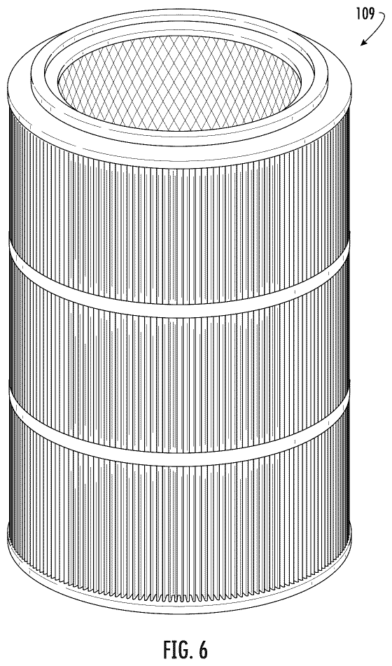

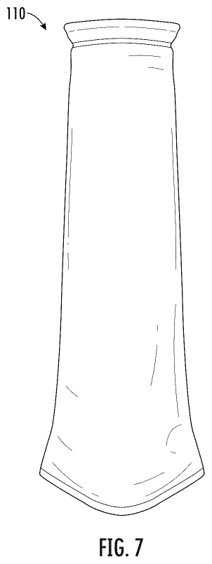

FIG. 6 illustrates a representative liquid filter 109 produced with various embodiments of porous membranes. The porous membrane is rolled into a cylinder, cone, or other suitable shape and may be used in applications, such as gas turbine and compressor air intake filters, panel filters and the like. A cartridge is a tubular filter medium that is encased inside a housing. The direction of flow in a cartridge filter is from outside to the insides of the cartridge. Cartridges are usually made from synthetic or natural fibers and small metal wires. A core, made of stainless or tin-plated steel or polypropylene, is present on the axis of the tubular cartridge to support the media material. A purer filtrate is collected at its core.

FIG. 7 illustrates a representative bag filter 110 produced with various embodiments of porous membranes. Bag filter 110 includes a porous membrane having staple fibers and nanoparticles dispersed through the depth of the substrate. Bag filters are one of the most popular filtration equipment. In this equipment, the process liquid passes through a permeable bag perforated with microscopic holes which act as the filter medium. The solid particles larger than the holes are entrapped and accumulated inside the bag. Its end has a sealing ring, usually made from stainless steel or plastic, to secure the bag inside the filtration vessel.

Other types of filters that may be developed with the nonwoven material disclosed herein include conical filter cartridges, pleated cartridges, wound cartridges, spun-bonded cartridges, square-end cap filter cartridges, activated carbon filter cartridges, reverse osmosis membrane cartridges, alkaline filter cartridges, ultraviolet filter cartridges, pocket filters, V-bank compact filters, panel filters, flat cell filters, pleated or unpleated bag cartridge filters, clean-in-place (CIP) filters and the like.

In another embodiment, the porous membrane is incorporated into an air filter that removes particles and contaminants from the air, such as a HEPA filter (i.e., pleated mechanical air filter), a UV light filter, an electrostatic filter, a washable filter, a media filter, a spun glass filter, pleated or unpleated air filters, active carbon filters, pocket filters, V-bank compact filters, filter sheets, flat cell filters, filter cartridges and the like. The porous membrane may comprise a filter media for the air filter and may be supported by a support layer, a scrim layer, or may be included in other layers or materials. The applicant has discovered that incorporating nanoparticles in depth into porous membranes as discussed herein substantially increases the efficiency of the air filter without compromising other factors, such as pressure drop (i.e., air flow) through the filter. In addition, these materials increase the overall dust holding capacity and thus the life of the filter, particularly compared to filters that rely solely or primarily on electrostatic effects to increase efficiency.

The porous membranes disclosed herein may also be used in medical masks or other medical applications, such as cartridges in respirators. Medical masks are designed to protect healthcare personnel and/or patients from microbials and other materials. For example, medical masks can block bacteria, which can have a dimension of about 3 microns, for example, as well as viruses, which can have a dimension of about 0.1 microns, for example. The masks are made using nonwoven materials in multiple layers and have ear loops, ties, or other structures for attaching the mask to a person's face. A wire may be incorporated into at least an upper portion of the mask so that at least that portion conforms to the person's face. The mask can include rigid polymeric structures designed to hold the multilayer nonwoven materials in front of a person's face. In one example, the mask has three layers. The outer layer and inner layer comprise a nonwoven material such as spunbond polypropylene that provides breathability, although any of the materials mentioned herein can be used.

The porous membranes disclosed herein may also be used in solid-liquid separation such as water purification. Water treatment systems may utilize membrane separation where any of the materials mentioned herein can be used.

In other embodiments, a filter comprises a filter media and a substantially rigid support layer bonded to the filter media. The support layer includes fibers and individual nanoparticles dispersed in depth within the layer. The nanoparticles are configured to filter contaminants passing through the support layer.

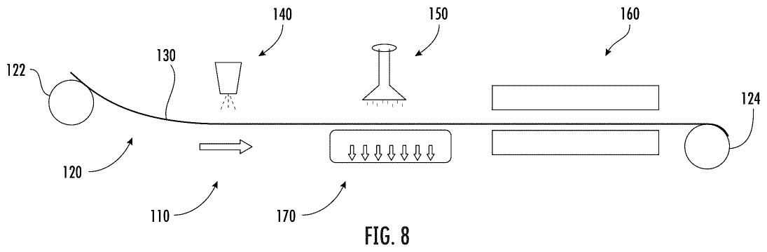

FIG. 8 schematically depicts an overall system 110 for manufacturing the nonwoven materials and other products described above. As shown, system 110 comprises a feeder 120 for advancing a substrate 130 of nonwoven fibers or other material through the manufacturing process. System 100 further includes a coater 140, a fiberization system 150 and a heating and/or drying device 160. In certain embodiments, system 100 further includes a vacuum or other source of negative pressure 170 underlying substrate 130 opposite fiberization system 150.

In one embodiment, feeder 120 comprises a winder 122 on the downstream end of the process and an unwinder 124 on the upstream end that continuously winds substrate 130 through system 100. In certain embodiments, feeder 120 may further comprise a support surface (not shown) extending between the winders for supporting substrate 130 as it moves downstream through system 100. In other embodiments, the substrate unwinds directly from unwinder 124 to winder 122 without another support surface.

Coater 140 is configured to spray droplets of a binding agent or binding material, such as an adhesive or binder, onto substrate 130 so that the nanoparticles can adhere to fibers within substrate 130 to form a stable matrix. The binding agent is preferably present in relatively small amounts to bond the individual nanoparticles to fibers throughout substrate 130. In a preferred embodiment, coater 140 comprises a spray nozzle sized to generate adhesive droplets having a diameter of about 20 to 30 microns to increase the penetration depth of the adhesive through substrate 130. Of course, the droplet size may be affected by numerous other parameters, including air pressure, the volume of the air, the temperature of air, humidity, spray horn design, rheology/viscosity of the adhesive, the carrier, and the like.

Of course, it will be recognized that coating the substrate with a binding agent or binding material may be achieved with other coating methods, which include ultrasonic spraying, dip coating, spin coating, gravure coating, kiss roll coating, screen coating, powder coating, electrostatic, sputter coating, or similar coating techniques.

As discussed above, the binding agent may comprise a variety of conventional materials, including natural-based materials, such as starch, dextrin, guar gum, or the like, or synthetic resins such as EVA, PVA, PVOH, SBR, and the like. In certain embodiments, solvent-based adhesives are used in which bonding occurs upon solvent evaporation.

In one preferred embodiment, the binding agent comprises a dextrin. In another embodiment, the binding agent comprises a composition of various substances, such as water, 2-hexoxyethanol, isopropanol amine, sodium dodecylbenzene sulfonate, lauramine oxide, and ammonium hydroxide. In yet another embodiment, the binding agent comprises PVOH. Binding agents could be in solution, emulsion, suspension, hot melt, curable, neat, and/or a combination.

In some embodiments, an adhesive resin is used and the adhesive resin may undergo cross-linking after the coating of the adhesive on substrate 130. Adhesion (water/solvent resistance) may be promoted by self-crosslinking as the solvent in the adhesive formulation evaporates or by heat activation during drying process. In the case of certain adhesives, crosslinking can be accomplished through high energy wavelengths of electromagnetic radiation including, but not limited to. RF, UV, or e-beam. The amount of adhesive can be controlled by adjusting the nozzle size of spray coater 140 or controlling the flow rate of the adhesive composition.

In some embodiments, the binding agent may include a surfactant to lower the surface or interfacial tension of the binding agent, thereby increasing its dispersion and wetting properties and allowing the binding agent to more easily penetrate into the depth of the substrate. Suitable surfactants for use with the binding agents disclosed herein include nonionic, anionic, cationic and amphoteric surfactants, such as sodium stearate, 4-(5-dodecyl) benzenesulfonate, sodium dodecylbenzene sulfonate wetting agents, docusate (dioctyl sodium sulfosuccinate), alkyl ether phosphates, benzalkonium chloride (BAC), perfluorooctanesulfonate (PFOS) and the like.

In some embodiments, spray coater 140 is located upstream of fiberization system 150 so that the binding agent is sprayed before the nanoparticles are deposited. In other embodiments, spray coater 140 is located downstream of fiberization system 150 so that the binding agent can be sprayed after nanoparticle deposition. In other embodiments, system 100 includes two spray coatings; one located upstream from fiberization system 150 and a second spray coater (not shown) located downstream of fiberization system 150 to coat substrate 130 with a secondary binding agent after deposition of the nanoparticles.

In some embodiments, there is more than one nozzle head with each spray coater 140. The nozzle heads may, for example, be disposed in series for better uniformity or to increase fiber spraying width. Alternatively, the nozzle heads may be located in parallel, i.e., across the width of the substrate, to ensure that the binding agent is coated throughout the width of the substrate.

In a preferred embodiment, a source of negative pressure or a vacuum (not shown) is disposed under substrate 130 opposite spray coater 140 to increase the penetration depth and uniformity of the binding agent. The source of negative pressure may be any suitable suction device that draws binding agents through the substrate, such as a suction pump or the like.

In some embodiments, the substrate includes its own binder composition. In these embodiments, the binding agent may, or may not, be added to the substrate. In one such embodiment, the substrate comprises biocomponent fibers 600, wherein one of the components comprises an outer sheath 64 at least partially surrounding an inner core 62. In certain embodiments, sheath 64 and core 62 may be substantially co-centric with each other (FIG. 5A). In other embodiments, the core 84 may be eccentric with the sheath 82 (FIG. 5C). In other embodiments, the core 72 and sheath 74 may lie side-by-side with each other (FIG. 5B). Of course, other configurations are possible. For example, the core 184 may comprise shapes other than circular, such as dog-bone shaped, square, triangular, diamond, or the like. Alternatively, the fiber 180 may comprise multiple cores, or it may be split into three, four or more quadrants.

The sheath 64 may comprise a material that bonds to the nanoparticles. For example, the sheath 64 may comprise a material that becomes tacky and/or fluid upon heating and/or drying. During the heating/drying step, the sheath 64 part of the fiber is heated up to its melting point until it becomes tacky and/or fluid to bond the nanoparticles to the substrate. In a preferred embodiment, bonding and drying take place at the same time within the drying device 160.

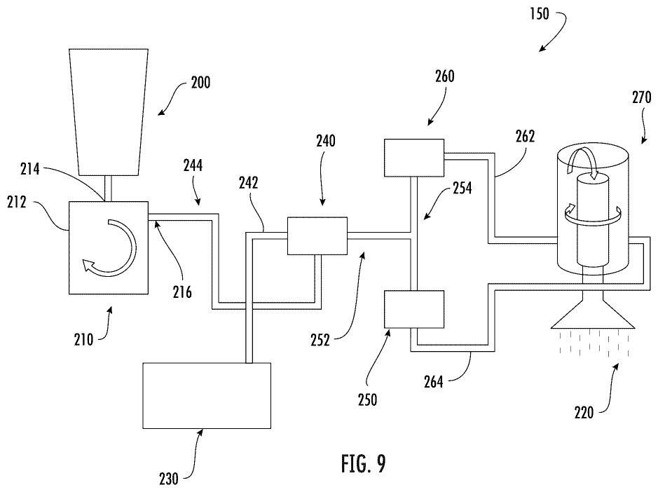

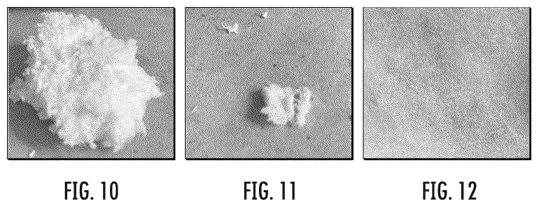

FIG. 9 schematically depicts a fiberization system 150 for converting groups of nanofibers into individual nanoparticles. The term “fiberization” as used herein means converting (e.g., opening up, separating, isolating and/or individualizing) clusters, clumps, or other groups of nanoparticles that ma, or may not, be entangled with each other into individual nanoparticles having at least one dimension less than 1 micron. FIGS. 10-12 illustrate examples of macro clusters of entangled nanofibers (FIG. 10), smaller clusters of entangled nanofibers (FIG. 11) and individual nanoparticles (FIG. 12).

As shown, fiberization system 150 includes a feeder 200, such a hopper, for introducing the larger or macro clusters/clumps of nanoparticles (see FIG. 10) into system 150. Feeder 200 may comprise any suitable hopper device known by those skilled in the art and preferably is configured to introduce macro clusters of particles into the process at a specified rate, which will depend on the rate of fiberization downstream. The nanoparticles may be introduced continuously at a specified rate, or an interval at a specific rate. The macro clusters of nanoparticles in bundles may be broken apart prior to introducing them into feeder 200.

It should be recognized that the nanoparticles may be introduced into fiberization device 150 in many different forms. For example, raw nanofibers may be produced as long separated fibers. In this form, the nanofibers may be cut to obtain the desired length to diameter ratio.

System 150 further includes a separator 210, such as a blender or the like, for separating or breaking down the macro clusters/clumps of nanoparticles into smaller clusters/clumps of nanoparticles (see FIG. 11). Feeder 200 transfers nanofibers into separator 210 by any mechanical means in a steady continuous state. The speed of transfer will depend on a variety of factors, such as the velocity of substrate 130 along feeder 120, the rate of fiberization of the nanoparticles and the like. With the help of controlling the amount of nanoparticles dropping into separator 210, the amount of nanoparticles dispersed into the substrate can be controlled to create a continuous manufacturing process.

In one embodiment, separator 210 includes a housing 212 with a first opening 214 coupled to feeder 200 and a second opening 216 coupled to the downstream process. The second opening 216 is preferably sized to only allow clusters of nanofibers having a certain size to pass therethrough. Separator 210 may include a plurality of rotatable blades (not shown) designed to rotate around a vertical axis within housing 212 to separate and open the coarse clusters of nanofibers. The blades may have the same, or different, pitches and cambers to allow for sequential breaking down or “opening” of the entangled fibers as they pass from first opening 214 to second opening 216.

Fiberization system 150 further includes a stream of gas that extends throughout the system from separator 210 to a nozzle 220 (discussed in more detail below). The stream of gas (along with a series of pumps as discussed below) provides the motive force to move the nanofibers through system 150. In one embodiment, the stream of gas is created with an air compressor 230 configured to supply compressed air to the system, although it will be recognized that other forms of gas may be used to transfer the nanofibers through system 150.

System 150 comprises one or more pumps for moving the clusters of nanofibers and eventually the individual nanoparticles throughout the system. Pumps may comprise any suitable pump, such as positive-displacement, centrifugal, axial-flow and the like. In one embodiment, a first pump 240 includes a first inlet fluidly coupled to air compressor 230 by a first passage 242 and a second inlet fluid coupled to separator 210 by a second passage 244. Compressed air is drawn into first pump 240, which creates a negative pressure (e.g., a vacuum) to draw clusters of nanofibers from separator 210 into pump (discussed in more detail below). System 150 may further include second and third pumps 250, 260 each fluidly coupled to the outlet of first pump 240. In a similar fashion, second and third pumps 250, 260 create negative pressures that draw the clusters of nanofibers through a third passage 252.

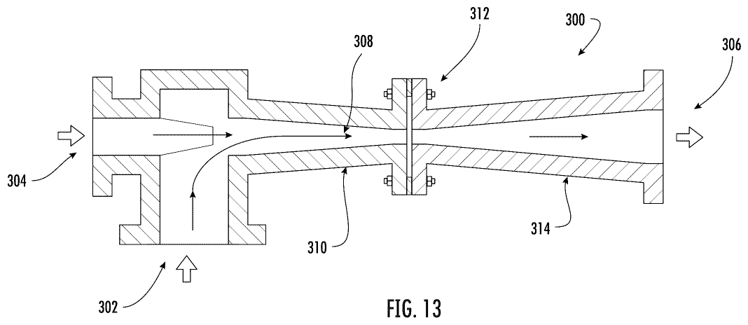

In certain embodiments, pumps 240 comprise eductors 300. As shown in FIG. 13, eductors 300 each comprise a motive fluid inlet 302 and a nanofiber inlet 304 coupled to an outlet 306 via a fluid passage 308. The fluid passage 308 includes a converging inlet nozzle 310, a diffuser throat 312, and a diverging outlet diffuser 314. High-pressure, low-velocity air is converted to low-pressure high-velocity air, thus producing the pressure difference required for suction. Based on the venturi effect and the Bernoulli principle, the primary fluid medium (e.g., compressed air) is used to create a vacuum to draw the nanofibers into the eductor 300 and to expel them through outlet 306. The diameter of the eductor 300 depends on the volumetric flow rate of the compressed air, the suction requirement, the pressure drop, and the fluid pressure of the compressed air.

Referring back to FIG. 9, third passage 252 includes a junction 254 that splits third passage 252 into two separate passages, each leading to second and third pumps 250, 260. Junction 254 preferably includes a surface or wall that is disposed substantially perpendicular to third passage 252 to form a T-shaped intersection. The surface may by any surface that opposes the flow of the nanofibers through the passage, such as the inner walls of the passage at a junction point, or other change in direction of the inner walls, e.g., a curved surface, a perpendicular surface or the like. Alternatively, the passage may include walls or other surfaces disposed within the passage or projecting into the passage in the fluid path. In one embodiment, the passage extends into a substantially T-shaped junction that includes two separate passages extending from the junction. The second eductor is configured to draw the nanofibers into the T-shaped junction at a velocity sufficient to break apart at least some of the nanofibers.

As the clusters of nanofibers move through third passage 252, they are propelled against this surface or wall by the negative pressure applied by second and third pumps 250, 260. This velocity of the nanofibers against junction 254 creates a collision with sufficient kinetic energy to cause at least some of the clusters of nanofibers to break up into smaller clusters of nanofibers and/or into individual nanoparticles having at least one dimension less than 1 micron.

In order to create the necessary kinetic energy to break down the clusters of nanofibers, the air is propelled throughout system 150 at a velocity of about 500 feet/minute (fpm) to about 10,000 feet/minute, preferably about 2,000 fpm to about 6,000 fpm. The system 150 includes a sufficient amount of suction pressure, preferably at least about 20 psi. This suction pressure creates an overall pressure throughout the system of at least about 100 psi.

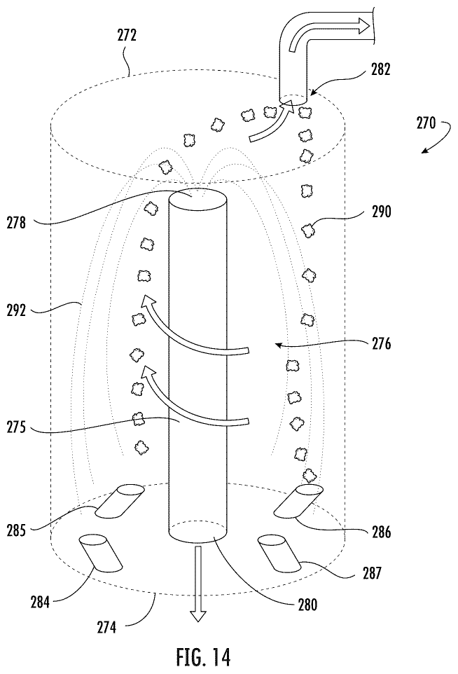

In certain embodiments, system 150 further includes fourth and fifth fluid passages 262, 264 that couple the outlets of second and third pumps 250, 260 with a reactor 270. As shown in FIG. 14, reactor 270 comprises a top surface 272, a bottom surface 274 and an internal annular chamber 276 extending from top surface 272 to the bottom surface 274. Reactor 270 further includes a central tube 275 having an open upper inlet 278 and an outlet 280. Reactor 270 may further include one or more upper outlet(s) 282. Reactor 270 may be coupled to a source of energy (not shown) that is configured to create a vortex of swirling gas within annular chamber 276. The source of energy may comprise any suitable energy source, such as a pump, compressor, generator and the like. The swirling gas preferably flows around central tube 275 from the bottom of reactor 270 to the top to move the clusters of nanofibers and the individual nanoparticles upwards from bottom surface 275 towards top surface 272.

In another embodiment, the vortex is created without a separate source of energy. In this embodiment, the clusters of nanofibers 290 and individual nanoparticles 292 enter the reactor 270 through bottom inlets 284, 285, 286, 287. Inlets 284, 285, 286, 287 are angled upwards to facilitate movement of the nanofibers and nanoparticles around central tube 275. In a preferred embodiment, at least one or more of the inlets 284, 285, 286, 287 is angled such that the nanofibers and nanoparticles enter the reactor 270 such that they are substantially tangential to central tube 275. Once they have entered annular chamber 276, the velocity vector (speed and direction) of the nanofibers and nanoparticles creates a vortex within reactor 270 that causes them to swirl around central tube 275 and upwards to the upper portion of chamber 276. The swirling gas preferably flows around central tube 275 from the bottom of reactor 270 to the top to move the clusters of nanofibers and the individual nanoparticles upwards from bottom surface 275 towards top surface 272. Without any interruption, the nanofibers 290 and nanoparticles 292 are blown from bottom of the reactor to the top. The vortex within chamber 276 may further break down (e.g., open up, separate and/or individualize) the clusters of nanofibers 290 as they pass through reactor 270.

In some embodiments, reactor 270 may also be coupled to a source of energy (not shown) that is configured to create the vortex of swirling gas within annular chamber 276. The source of energy may comprise any suitable energy source, such as a pump, compressor, generator, and the like.

The system 100 may further include another pump or source of negative pressure (see, for example, FIG. 14) coupled to upper outlet 282. This negative pressure draws fibers through outlet 282 such that the fibers 290 exit the reactor 270. Since the individual nanoparticles 292 are significantly lighter than the entangled nanofibers 290 that are still clustered together, these individual nanoparticles 292 are drawn into upper inlet 278 of central tube 275. Meanwhile, the larger and heavier clusters of nanofibers 290 that have not yet been broken down are drawn through upper outlet 284. Upper outlet 284 may be coupled to other pumps (not shown), or to first pump 240. In this manner, the clusters of nanofibers 290 are sent through the process again to become further broken down, creating a refeed system to further break down the remaining clusters of nanofibers.

Outlet 280 of central tube 275 is coupled to nozzle 220 (see FIG. 9). The individual nanoparticles 292 are drawn into nozzle 220, where they are dispersed onto a surface of the substrate or into a fiber stream (discussed below). Nozzle 220 may comprise any suitable nozzle known by those in the art. In one embodiment, nozzle 220 has a plurality of outlets having an outer dimension tailored for the size (i.e., area) of the substrate passing below nozzle 220. The nozzle 220 will disperse the nanoparticles onto the substrate at a rate that is driven by the pressure throughout the system.

In certain embodiments, system 100 comprises more than one nozzle coupled to the outlet 280 of reactor 270. The nozzles may be arranged in any suitable form over the substrate, e.g., side-by side, in series, in parallel, or the like.

It will be recognized that pump 240, or pumps 250, 260 may directly feed the nanofiber/air mixture stream into the nozzle 220 (i.e., bypassing reactor 270). In this embodiment, the pressure within system is designed to create sufficient kinetic energy to break down or open up substantially all of the nanofibers into individual nanoparticles such that reactor 270 is not required to separate the nanoparticles from the larger clusters of fibers.

Referring now to FIG. 15, another embodiment of a fiberization system 320 will now be described. As shown, fiberization system 320 includes a separator 325 for separating larger or macro clusters of nanofibers into the smaller clusters of nanofibers that will pass through system 320. A first eductor 326 is coupled to an outlet of separator 325 and serves to draw the nanofibers from separator 325 and into system 320. An air compressor (not shown) is also coupled to eductor 326 to provide the motive fluid, as discussed above.

Similar to the previous embodiment, second and third eductors 330, 340 are coupled to an outlet of the first eductor 326. The nanofibers are drawn through first eductor 320 and propelled against a surface of a T-shaped intersection 350 to break down at least some of the nanofibers into smaller clusters or individual nanoparticles.

Each of the second and third eductors 330, 340 have outlets coupled to additional T-shaped intersections 360, 370. As before, nanofibers are propelled against the surface of the T-shaped intersection 360, 370 to further break them down. The T-shaped intersections 360, 370 are each coupled to two fluid passages that enter the bottom portion 380 of a reactor. Thus, bottom portion 380 of reactor has four separate inlets 382, 384, 386, 388 for passage of the nanofibers. Each of these inlets is preferably angled upwards and positioned in opposite corners of the reactor. This allows the nanofibers to enter into the vortex of the reactor and then swirl upwards to an upper portion 390 of the reactor.

As discussed previously in reference to FIG. 14, the reactor includes an annular chamber with a central tube having an open upper end and a lower end coupled to a nozzle. The nanofibers that have been sufficiently broken down into individual nanoparticles flow through this open upper end and into the central tube for dispersion through the nozzle. The heavier clusters of nanoparticles that have not yet been broken down exit the reactor through one of four separate outlets 392, 394, 396, 398. Eductors 410, 420 provide the motive force for drawing the nanofibers from reactor 400, as discussed above. Outlets 392, 394 are each coupled to eductor 410 via a T-shaped intersection 412 and outlets 396, 398 are each coupled to eductor 420 via a T-shaped intersection 422. In this case, the nanofibers flow from two passages into one passage as they pass through intersections 412, 422.

Eductors 410, 420 are each coupled to T-shaped intersections 430, 440. As described before, the nanofibers are propelled into T-shaped intersections 430, 440 to further break them down into individual nanoparticles. T-shaped intersections 430, 440 are then each coupled to the bottom portion 380 of reactor 400 (via inlets 432, 434, 442, 444). This allows the nanofibers to pass back into reactor 400 for further processing. This process continues for each cluster of nanofibers until it has been entirely broken down into nanoparticles and passed through the central tube into the nozzle. As a last step, individualized nanofibers are air sprayed from the nozzle onto any substrate or mixed with any fiber spinning stream. During this process, suction is up to 20 psi, pressure is up to 100 psi.

In certain embodiments, fiberization system 150 may include a separate control system that monitors the nanofibers to determine when they have been broken down into individual nanoparticles suitable for passing through nozzle. The control system may, for example, simple monitor the pressure throughout the system to ensure that sufficient pressure is being applied to the nanofibers to break them down into nanoparticles. Alternatively, this control system may comprise a variety of different sensors disposed through the system to detect characteristics of the nanoparticles, such as weight or size. The sensors may be disposed, for example within reactor 400 such that the control system may control various parameters of reactor 400, such as the negative pressure applied to outlets, 392, 394, 396, 398, the speed of the vortex passing around the annular chamber, or the pressure applied to central tube that draws then nanoparticles into the nozzle.

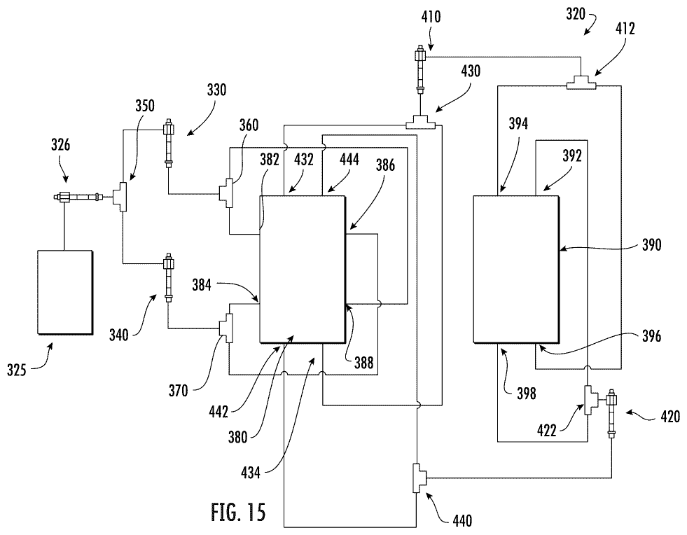

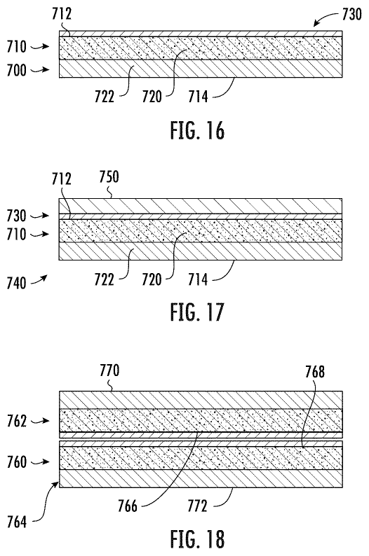

FIG. 16 illustrates a filter product 700 including a filter media 710 comprising a porous membrane including fibers 722 and nanoparticles 720 dispersed through at least a portion of filter media 710. As shown, filter media 710 has a first upper surface 712 and a second lower surface 714. The nanoparticles have been dispersed through upper surface 712 such that they extend beyond upper surface 712 and into the depth of filter media 710, as discussed above. Filter product 700 further includes a support layer 730, which may be any suitable support layer known in the art, such as a substantially rigid polymer that provides support for filter media 710, or an apertured film having a plurality of apertures for passage of gas or fluid therethrough (discussed above).

FIG. 17 illustrates another filter product 740 that includes a filter media 710 comprising a porous membrane including fibers 722 and nanoparticles 720 dispersed through a portion of filter media 710. In this embodiment, product 740 includes a scrim layer 750 bonded to a support layer 730.

FIG. 18 illustrates a dual-layer filter product 760 that includes first and second filter medias 762, 764 bonded to each other. As shown, nanoparticles 720 have been dispersed throughout a depth of each filter media 762, 764. In this embodiment, nanoparticles 720 have been dispersed through inner surfaces 766, 768 of filter media 762, 764. In another embodiment (not shown), the nanoparticles are dispersed through outer surfaces 770, 772 of filter media 762, 764. In yet another embodiment, nanoparticles 720 may be deposited on inner surface 766 of media 762 and outer surface 772 of media 764.

A more complete description of filter media incorporating nanoparticles can be found in commonly assigned, co-pending U.S. patent application Ser. Nos. 18/297,187, 18/297,188, 18/297,194, 18/297,198, 18/297,203, 18/297,209, 18/297,217, 18/297,223, 18/297,226, 18/297,232, 18/297,239 and 18/297,247 all of which were filed Apr. 4, 2023, and U.S. Provisional Application Ser. No. 63/585,693, filed Sep. 27, 2023, 63/585,697, filed Sep. 27, 2023 and 63/588,326, filed Oct. 6, 2023, the complete disclosures of which are incorporated herein by reference in their entirety for all purposes.

While the devices, systems and methods have been described in detail herein in accordance with certain preferred embodiments thereof, many modifications and changes therein may be affected by those skilled in the art. Accordingly, the foregoing description should not be construed to be limited thereby but should be construed to include such aforementioned obvious variations and be limited only by the spirit and scope of the following claims.

In some embodiments, nanoparticles are dispersed between continuous fibers such as spunbond and meltblown. Spunbond media could be made of monocomponent or bicomponent fibers.

For example, in a first aspect, a first embodiment is a filter media comprising a porous membrane comprising fibers and having a mean flow pore size of less than about 10 microns and nanoparticles disposed within the porous membrane.

A second embodiment is the first embodiment and wherein the fibers comprise staple fibers.

A third embodiment is any combination of the first two embodiments, wherein the fibers are wet-laid fibers.

A fourth embodiment is any combination of the first three embodiments, wherein the fibers are nonwoven fibers.

A fifth embodiment is any combination of the first four embodiments, wherein the staple fibers have a length of about 2 mm to about 10 mm.

A sixth embodiment is any combination of the first five embodiments, wherein the fibers comprise polyolefins, polyester, polyethylene (PE), polypropylene (PP), blends of PP and PE, PBT, PET, CoPET, PLA, PA, PHB, PVOH, polyamide and combination thereof.

A seventh embodiment is any combination of the first six embodiments, wherein the fibers comprise polyester.

An eighth embodiment is any combination of the first seven embodiments, wherein the mean pore size is less than about 5 microns.

A ninth embodiment is any combination of the first eight embodiments, wherein the mean pore size is less than about 4 microns.

A tenth embodiment is any combination of the first nine embodiments, wherein the filter media has a bubble point of about 5 microns to about 50 microns.

An eleventh embodiment is any combination of the first ten embodiments, wherein the filter media has a bubble point of less than about 20 microns.

A twelfth embodiment is any combination of the first eleven embodiments, wherein the filter media has a bubble point of less than about 10 microns.

A thirteenth embodiment is any combination of the first twelve embodiments, wherein the filter media has a bubble point of about 5 microns.

A 14th embodiment is any combination of the first 13 embodiments, wherein the filter media is configured for use as a liquid filter.

A 15th embodiment is any combination of the first 14 embodiments, wherein the porous membrane has a thickness from a first surface to a second surface, wherein the nanoparticles are disposed within the porous membrane in at least 25% of the thickness from the first surface to the second surface.

A 16th embodiment is any combination of the first 15 embodiments, wherein the nanoparticles are disposed within the porous membrane in at least 50% of the thickness from the first surface to the second surface.

A 17th embodiment is any combination of the first 16 embodiments, wherein the fibers are biocomponent fibers.

An 18th embodiment is any combination of the first 17 embodiments, wherein the nanoparticles are substantially uniformly dispersed throughout the porous membrane.

A 19th embodiment is any combination of the first 18 embodiments, wherein the nanoparticles are generated within a gas and dispersed through a first surface of the porous membrane.

A 20th embodiment is any combination of the first 19 embodiments, further comprising a binding agent within the porous membrane retaining the nanoparticles in the porous membrane.

A 21^{st} embodiment is any combination of the first 20 embodiments, wherein the nanoparticles are selected from a group consisting of carbon fibers, glass fibers, polypropylene fibers, nylon fibers, polylactide fibers, polyester fiber, fibrillated cellulose, polyethylene fibers and combinations thereof.

A 22^{nd} embodiment is any combination of the first 21 embodiments, wherein the nanoparticles have at least one dimension less than about 20 microns.

A 23^{rd} embodiment is any combination of the first 22 embodiments, wherein the nanoparticles have at least one dimension between about 1 micron and about 20 microns.

A 24^{th} embodiment is any combination of the first 23 embodiments, wherein the nanoparticles have at least one dimension less than about 1 micron.

In a second aspect, a first embodiment is a liquid filter comprising a porous membrane comprising fibers and having a mean pore size of less than about 10 microns, wherein the filter has a bubble point of about 5 to about 50 microns.

A second embodiment is the first embodiment, wherein the bubble point is less than about 20 microns.

A third embodiment is any combination of the first 2 embodiments, wherein the bubble point is less than about 10 microns.

A 4^{th} embodiment is any combination of the first 3 embodiments, wherein the bubble point is about 5 microns.

A 5^{th} embodiment is any combination of the first 4 embodiments, wherein the mean pore size is less than about 5 microns.

A 6^{th} embodiment is any combination of the first 5 embodiments, wherein the mean pore size is less than about 4 microns.

A 7^{th} embodiment is any combination of the first 6 embodiments, wherein the porous membrane comprises staple fibers.

An 8^{th} embodiment is any combination of the first 7 embodiments, wherein the fibers comprise staple fibers having a length of about 2 to about 10 mm.

A 9^{th} embodiment is any combination of the first 8 embodiments, wherein the staple fibers comprise polyolefins, polyethylene (PE), polypropylene (PP), blends of PP and PE, PBT, PET, CoPET, PLA, PA, PHB, polyamide and combination thereof.

A 10^{th} embodiment is any combination of the first 9 embodiments, further comprising nanoparticles disposed within the porous membrane, wherein the nanoparticles have at least one dimension less than 1 micron.

An 11^{th} embodiment is any combination of the first 10 embodiments, wherein the nanoparticles are generated within a gas and dispersed through a first surface of the porous membrane.

A 12^{th} embodiment is any combination of the first 11 embodiments, further comprising a housing comprising an inlet for receiving a liquid and an outlet for discharging the liquid, wherein the filter media is disposed within the housing between the inlet and the outlet.

A 13^{th} embodiment is any combination of the first 12 embodiments, wherein the housing comprises a cartridge.

A 14^{th} embodiment is any combination of the first 13 embodiments, wherein the housing comprises a bag.

In a third aspect, a first embodiment is a method for manufacturing a filter media, the method comprising providing a porous membrane comprising staple fibers and dispersing nanoparticles into a first surface of the porous membrane such that the nanoparticles penetrate through at least said first surface, wherein the nanoparticles reduce a mean flow pore size of the porous membrane to less than about 10 microns.

A second embodiment is the first embodiment, wherein the nanoparticles reduce the mean flow pore size of less than about 5 microns.

A 3rd embodiment is any combination of the first 2 embodiments, wherein the nanoparticles reduce the mean flow pore size of less than about 4 microns.

A 4^{th} embodiment is any combination of the first 3 embodiments, wherein the nanoparticles reduce the mean flow pore size to about 3 microns.

A 5^{th} embodiment is any combination of the first 4 embodiments, further comprising generating the staple fibers through a wet-laid process.

A 6^{th} embodiment is any combination of the first 5 embodiments, further comprising calendaring the staple fibers and the nanoparticles.

A 7^{th} embodiment is any combination of the first 6 embodiments, further comprising spraying the individual nanoparticles onto a first surface of the porous membrane.

An 8^{th} embodiment is any combination of the first 7 embodiments, further comprising applying suction to a second surface of the first layer opposite the first surface to draw the individual nanoparticles through the first layer.

A 9^{th} embodiment is any combination of the first 8 embodiments, further comprising applying a binding agent to the fibers within the porous membrane.

A 10^{th} embodiment is any combination of the first 9 embodiments, wherein the porous membrane has a bubble point of about 5 microns to about 50 microns.

An 11^{th} embodiment is any combination of the first 10 embodiments, wherein the porous membrane has a bubble point of less than about 20 microns.

A 12^{th} embodiment is any combination of the first 11 embodiments, wherein the porous membrane has a bubble point of less than about 10 microns.

A 13^{th} embodiment is any combination of the first 12 embodiments, wherein the porous membrane has a bubble point of about 5 microns.

A 14^{th} embodiment is a liquid filter produced from the process of any of the first 13 embodiments.

What is claimed is:

1. A filter media comprising:
a porous membrane comprising fibers and having a mean flow pore size of less than about 10 microns; and
nanoparticles disposed within the porous membrane.

2. The filter media of claim 1, wherein the fibers are wet-laid fibers.

3. The filter media of claim 1, wherein the fibers comprise polyolefins, polyester, polyethylene (PE), polypropylene (PP), blends of PP and PE, PBT, PET, CoPET, PLA, PA, PHB, PVOH, polyamide and combination thereof.

4. The filter media of claim 1, wherein the mean pore size is less than about 5 microns.

5. The filter media of claim 1, wherein the mean pore size is less than about 4 microns.

6. The filter media of claim 1, wherein the porous membrane has a thickness from a first surface to a second surface, wherein the nanoparticles are disposed within the porous membrane in at least 25% of the thickness from the first surface to the second surface.

7. The filter media of claim 6, wherein the nanoparticles are disposed within the porous membrane in at least 50% of the thickness from the first surface to the second surface.

8. The filter media of claim 1, wherein the nanoparticles are substantially uniformly dispersed throughout the porous membrane.

9. The filter media of claim 1, wherein the nanoparticles are generated within a gas and dispersed through a first surface of the porous membrane.

10. The filter media of claim 1, wherein the nanoparticles have at least one dimension less than about 20 microns.

11. A liquid filter comprising:
a porous membrane comprising fibers and having a mean pore size of less than about 10 microns; and
wherein the filter has a bubble point of about 5 to about 50 microns.

12. The liquid filter of claim 11, wherein the bubble point is less than about 20 microns.

13. The liquid filter of claim 11, wherein the bubble point is less than about 10 microns.

14. The liquid filter of claim 11, wherein the bubble point is about 5 microns.

15. The liquid filter of claim 11, wherein the mean pore size is less than about 5 microns.

16. The liquid filter of claim 11, wherein the mean pore size is less than about 4 microns.

17. The liquid filter of claim 11, wherein the fibers comprise staple fibers having a length of about 2 to about 10 mm.

18. The liquid filter of claim 17, further comprising nanoparticles disposed within the porous membrane, wherein the nanoparticles have at least one dimension less than about 20 microns.

19. The liquid filter of claim 18, wherein at least some of the nanoparticles are bonded to at least some of the staple fibers.

20. The liquid filter of claim 18, wherein the nanoparticles are generated within a gas and dispersed through a first surface of the porous membrane.
